(19) United States
(12) Patent Application Publication
(10) Pub. No.: US 2009/0246581 A1
(43) Pub. Date: Oct. 1, 2009

(54) FUEL CELL SYSTEM AND COOLING AIR SUPPLYING METHOD OF FUEL CELL

(76) Inventors: Yuusuke SATO, Tokyo (JP); Eiichi Sakaue, Tokyo (JP); Norihiro Tomimatsu, Mitaka-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/403,540

(22) Filed: Mar. 13, 2009

(30) Foreign Application Priority Data
Mar. 27, 2008 (JP) 2008-083426

(51) Int. Cl. H01M 8/04

(52) U.S. Cl. 429/24; 429/26; 429/13

(57) ABSTRACT

In a method of cooling a fuel cell, a fuel cell is provided with a housing in which first and second flow paths are defined to flow first and second airflows on first and second surfaces of the fuel cell, and the first flow path is communicated with the second flow path through air flow paths formed in a cathode electrode of the cell. An adjustable pressure difference is produced between the first and second airflows in the first and second flow paths to produce airflows in the air flow paths. Thus, the airflows in the air flow paths are adjusted in accordance with the pressure difference.

### CROSS-REFERENCE TO RELATED APPLICATIONS

This application is based upon and claims the benefit of priority from prior Japanese Patent Application No. 2008-083426, filed Mar. 27, 2008, the entire contents of which are incorporated herein by reference.

### BACKGROUND OF THE INVENTION

1. Field of the Invention

The present invention relates to a cooling air supply method of a fuel cell for cooling a fuel cell and supplying air to an air flow path of a fuel cell, and a fuel cell system.

2. Description of the Related Art

A fuel cell is known as a system for taking out a change in free energy obtained by a chemical reaction between fuel and an oxidizing agent to the outside as electricity in JP-A 2007-095581 (KOKAI), JP-A2005-216777 (KOKAI) and JP-A H11-67249 (KOKAI). The fuel is mainly hydrogen or a hydrocarbon-based organic compound, and the oxidizing agent is mostly oxygen. In order to take out the free energy change resulting from the chemical reaction between the fuel and the oxidizing agent as electric energy, the fuel cell includes two electrodes serving as electron conductors, and an electrolyte serving as an ion conductor.

The fuel cell is classified into several types according to the type of the fuel or electrolyte. For example, the systems of the fuel cell include a direct methanol fuel cell (DMFC) system, molten carbonate fuel cell (MCFC) system, polymer electrolyte fuel cell (PEFC) system, and the like.

The direct methanol fuel cell has a structure in which an electrolyte is interposed between an anode which is a negative electrode, and a cathode which is a positive electrode. Methanol (CH₃OH) and water (H₂O) are supplied to the anode of the fuel cell. Normally, the methanol and water are supplied in the form of a mixture of both of them such as an aqueous solution of methanol. On the other hand, oxygen (O₂) is supplied to the cathode side of the fuel cell.

A reaction of the following formula (1) occurs on the anode side of the fuel cell.

CH₃OH+H₂O→CO₂+6H⁺+6e⁻−121.9 kJ/mol (1)

A reaction of the following formula (2) occurs on the other side of the fuel cell, i.e., on the cathode side.

3/2O₂+6H⁺+6e⁻→3H₂O+141.95 kJ/mol (2)

Here, the electrolyte membrane of the fuel cell has the selectivity of not transmitting an electron (e−), and transmitting only a proton (H+). Accordingly, the electron has inevitably to travel toward the cathode side through an external circuit outside the fuel cell, and the electron (e−) supplied to the external circuit is taken out to the outside as electric energy.

As described above, the fuel cell requires supply of oxygen (O₂) to the positive side electrode, and the oxygen is normally supplied to the positive side electrode by using a pump.

On the other side, in the fuel cell, it is difficult to convert the entire energy held in the fuel into electric energy because of the internal resistance of the fuel cell at the time of the occurrence of the reactions of the formulae (1) and (2), and a conversion loss is caused. For this reason, a large-output fuel cell requires a function of forcedly radiating heat, and is thus cooled by a cooling fan. That is, the fuel cell requires both an air supply function for supplying oxygen to the cathode, and an air supply function for cooling the fuel cell, and two fans including an air-supply pump, and a cooling fan are provided in many of the fuel cell systems. It is also proposed, for the purpose of size reduction and simplification of the fuel cell system, that both the air-supply pump and the cooling fan be unified.

For example, in JP-A 2007-095581 (KOKAI), there is disclosed a fuel cell having a structure in which fuel cells as the electricity generation parts are stacked in a container. In the fuel cell, each fuel cell is constituted of a membrane electrode assembly, an anode-side plate, and a cathode-side plate, an opening part is provided in the container, an airflow is made to flow into the container from a fan provided outside the container through the opening part, and the airflow is made to flow out through the opening part. Here, the cathode-side plate is arranged in such a manner that the cathode-side plate is in contact with the airflow, and oxygen contained in the airflow is supplied to the membrane electrode assembly to be used for generation of electricity.

In JP-A 2007-095581 (KOKAI), there is disclosed a structure wherein a manifold and an opening adjustable valve are attached to one end of the cathode-side plate, thus a forced flow is prevented from being formed in the cathode-side flow path, and furthermore, an amount of supply of air to the cathode is adjusted.

However, according to the method disclosed in JP-A 2007-095581 (KOKAI), there is a problem that when the flow rate of the cooling path is adjusted for temperature control, the flow rate of the flow to the cathode-side flow path used for generation of electricity is also changed concomitantly with the adjustment. In order to solve the problem, JP-A 2005-216777 (KOKAI) and JP-A H11-67249 (KOKAI) disclose a structure in which distribution to the cooling path and the cathode is adjusted by means of a mechanical device such as a slit and the like.

However, with the mechanical device, the number of components becomes large, and there is the problem that reduction in size is hindered, causes of failures are increased, and the cost is also increased. Further, in the structure disclosed in JP-A 2005-216777 (KOKAI) and JP-A H11-67249, the flow rate is adjusted by a very small difference in the flow path cross-sectional area, and hence there is also the problem that the control of the flow rate is difficult.

### BRIEF SUMMARY OF THE INVENTION

According to an aspect of the present invention, there is provided a fuel cell system comprising:

first and second airflow generation parts configured to generate first and second cooling airflows, respectively;

a fuel cell having first and second surfaces faced to each other and including a cathode-side plate having air flow paths, an anode-side plate having fuel flow paths through which fuel flows, and a membrane electrode assembly arranged between the cathode-side and the anode-side plates, and in contact with the air flow paths and the fuel flow paths, wherein the air flow paths has first openings at one ends thereof, which are arranged on the first surface, and the air flow paths has second openings at the other ends thereof, which are arranged in the second surface;

a housing which receive the fuel cell, the housing having inner surfaces defining first and second cooling flow paths between the inner surfaces and the first and second surfaces, respectively, wherein the first and second cooling airflows flows through the first and second cooling flow paths, respectively, and the first cooling flow path is communicated with the second cooling flow path through the air flow paths; and

a control unit configured to control a pressure difference between the first and second cooling airflows in the first and second cooling flow paths, respectively, to control airflows introduced from the first cooling flow path into the air flow paths in accordance with the pressure difference.

Further, according to an another aspect of the present invention, there is provided a method of controlling a cooling airflow for a fuel cell, the fuel cell having first and second surfaces faced to each other and including a cathode-side plate having air flow paths, an anode-side plate having fuel flow paths through which fuel flows, and a membrane electrode assembly arranged between the cathode-side and the anode-side plates, and in contact with the air flow paths and the fuel flow paths; the method comprising:

supplying first and second cooling airflows into first and second cooling flow paths defined on the first and second surfaces, respectively, wherein the first cooling flow path is communicated with the second cooling flow path through the air flow paths; and

controlling the pressure difference between the first and second cooling airflows in the first and second cooling flow paths, respectively, to control airflows introduced from the first cooling flow path into the air flow paths in accordance with the pressure difference.

### BRIEF DESCRIPTION OF THE SEVERAL VIEWS OF THE DRAWING

FIG. 1 is a block diagram schematically showing a fuel cell system of an embodiment.

FIG. 2 is a perspective view schematically showing the cell structure of the fuel cell shown in FIG. 1.

FIG. 3 is a perspective view schematically showing an arrangement of the fuel cell shown in FIG. 2.

FIG. 4 is a cross-sectional view schematically showing the cross-sectional structure of the fuel cell shown in FIG. 2.

FIG. 5 is a control block diagram showing the control operations in the fuel cell system shown in FIG. 1.

FIG. 6A is a table showing relationships between an amount of air supply to the cathode side and an amount of air supply from each of first and second fans in the fuel cell shown in FIG. 4.

FIG. 6B is a graph showing an example of an amount of air of a total airflow supplied from the first and second fans to cool the fuel cell shown in FIG. 4 when the amount of air supplied to the cathode side is set constant.

FIG. 7 is a cross-sectional view schematically showing the cross-sectional structure according to a modified embodiment of the fuel cell shown in FIG. 4.

FIG. 8 is a cross-sectional view schematically showing the cross-sectional structure according to another modified embodiment of the fuel cell shown in FIG. 4.

FIG. 9 is a cross-sectional view schematically showing the cross-sectional structure according to still another modified embodiment of the fuel cell shown in FIG. 4.

### DETAILED DESCRIPTION OF THE INVENTION

A fuel cell according to an embodiment of the present invention will be described below with reference to the accompanying drawings.

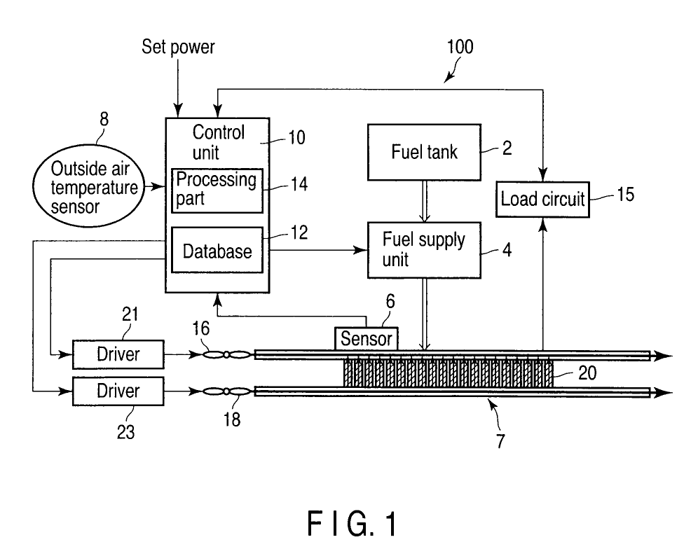

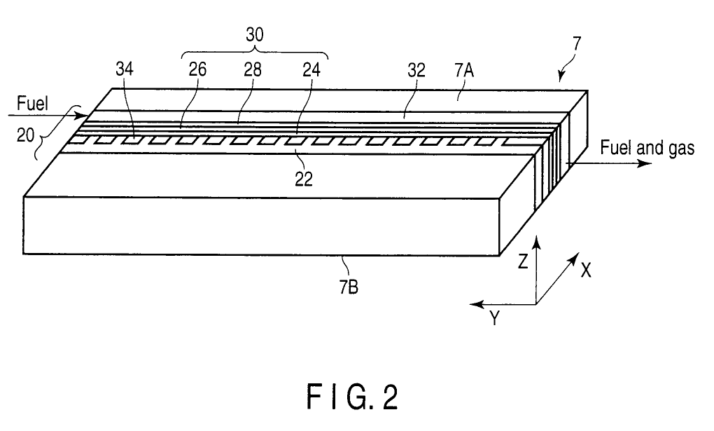

FIG. 1 shows a fuel cell system 100 provided with a fuel cell of the present invention, and FIG. 2 shows the fuel cell shown in FIG. 1.

As shown in FIG. 1, in the fuel cell system, a high concentration methanol solution or a pure methanol solution is stored in a fuel tank 2 as the fuel. In order to supply the fuel from the fuel tank 2 to the fuel cell 7, the fuel cell system 100 is provided with a fuel supply unit 4. The fuel cell 7 is provided with a temperature sensor 6 for measuring the temperature of the fuel cell, the temperature of the fuel cell is raised on the basis of a reaction concomitant with generation of electricity in the fuel cell 7, and the measured temperature is input to a control unit 10 as a measurement signal. Further, the fuel cell system 100 is provided with a temperature sensor 8 for measuring a circumstance temperature, and an output signal (measurement signal) from the temperature sensor 8 is also input to the control unit 10. A set value of power (target power) to be output from the fuel cell is input to the control unit 10 from outside. In the control unit 10, output signals from the temperature sensors 6 and 8 are compared with data in a database 12, and a supply amount of fuel to be supplied to the anode side of the fuel cell 7 for the target power is determined by a processing unit 14 on the basis of the above comparison between the output signals and the data. The determined fuel supply amount is supplied to the fuel supply unit 4 as a control signal, and the fuel supply unit 4 supplies the fuel of the supply amount set for the fuel cell on the basis of the control signal to the fuel cell 7.

As shown in FIG. 1, the fuel cell 7 is provided with first and second fans 16 and 18 as a cooling wind generation part for generating first and second cooling airflows (cooling winds). The fuel cell 7 is further provided with drivers 21 and 23 for driving the first and second fans 16 and 18 independent of each other. In the control unit 10, the output signals from the temperature sensors 6 and 8 are compared with data in the database 12 having a look-up table, and the supply amount of cooling air (cooling wind) to be supplied to the cathode side of the fuel cell 7 is determined by the processing unit 14 on the basis of the above comparison between the output signals and the data. On the basis of the supply amount of air for generation of electricity determined by the method to be described later, and this supply amount of the cooling air, first and second rotational speeds of the first and second fans 16 and 18 are determined. A control command is input to each of the first and second drivers 21 and 23 from the control unit 10 in order that the first and second fans 16 and 18 can be rotated at the determined first and second rotational speeds. Accordingly, the first and second fans 16 and 18 are driven by drive signals from the first and second drivers 21 and 23, the first and second fans 16 and 18 rotate at the set first and second rotational speeds, and the first and second airflows for electricity generation and cooling are supplied to the upper part and the lower part of the fuel cell from the first and second fans 16 and 18, whereby the predetermined amount of air is supplied to the cathode side of the fuel cell 7. Incidentally, the terms “upper part” and “lower part” are used for convenience of description in this embodiment, and it is allowed that these terms are changed to “left side” and “right side” according to the posture of the fuel cell 7.

As shown in FIG. 2, the fuel cell 7 has a structure in which a plurality of fuel cells 20 are stacked in X direction (width direction of the fuel cell), each fuel cell 20 is constituted of a cathode-side plate 22, and an anode-side plate 32 opposed to the cathode-side plate 22, and a membrane electrode assembly (MEA) 30 is arranged between the cathode-side plate 22 and the anode-side plate 32. Only a single fuel cell 20 is shown in FIG. 2, but another fuel cell or cells may be provided in the system. In the membrane electrode assembly (MEA) 30, a cathode catalyst layer 24 is in close contact with the cathode-side plate 22, further an anode catalyst layer 28 is in close contact with the anode-side plate 32, and a proton-conducting membrane (proton-conducting polymeric membrane) 26 is arranged between the cathode catalyst layer 24 and the anode catalyst layer 28 to be in close contact with the cathode catalyst layer 24 and the anode catalyst layer 28. A large number of air flow paths 34 for airflow (air supply) are formed in the cathode-side plate 22 in the Z direction, and are opened at the top and under surfaces 7A and 7B of the fuel cell 7. Further, an input port and an output port (not shown) are formed on the end face of the anode-side plate 32, a curved fuel flow path (not shown) for passing fuel therethrough is formed in such a manner that the fuel flow path communicates with the input and output ports, and fuel is brought into contact with the anode catalyst layer 28 in this fuel flow path. The fuel reacts on the anode catalyst layer 28, and a proton produced here reaches the cathode catalyst layer 24 through the proton-conducting membrane (proton-conducting polymeric membrane) 26. Here, the proton reacts with air passed through the cathode catalyst layer 24, and produces water. The membrane electrode assembly (MEA) 30 is hermetically sealed by a seal, i.e., a gasket (not shown), and is formed into a structure from which the fuel does not leak.

Incidentally, in the structure shown in FIG. 2, although a plurality of fuel cells 20 are arrayed in the X direction (width direction of the fuel cell), it is evident that the plurality of fuel cells 20 may be arrayed in the Y direction (longitudinal direction of the fuel cell).

The control unit 10 gives a load setting instruction to set a load in order to set the power (target power) to be output from the fuel cell 7 to a load circuit 15 shown in FIG. 1, the power output from the fuel cell 7 is measured, and an output signal is supplied to the control unit 10, thereby enabling the control unit 10 to monitor the output of the fuel cell 7. In FIG. 2, only a single cell 20 is shown for simplifying the drawing, but the system may provided with another cells 20 which are stacked on the cell 20.

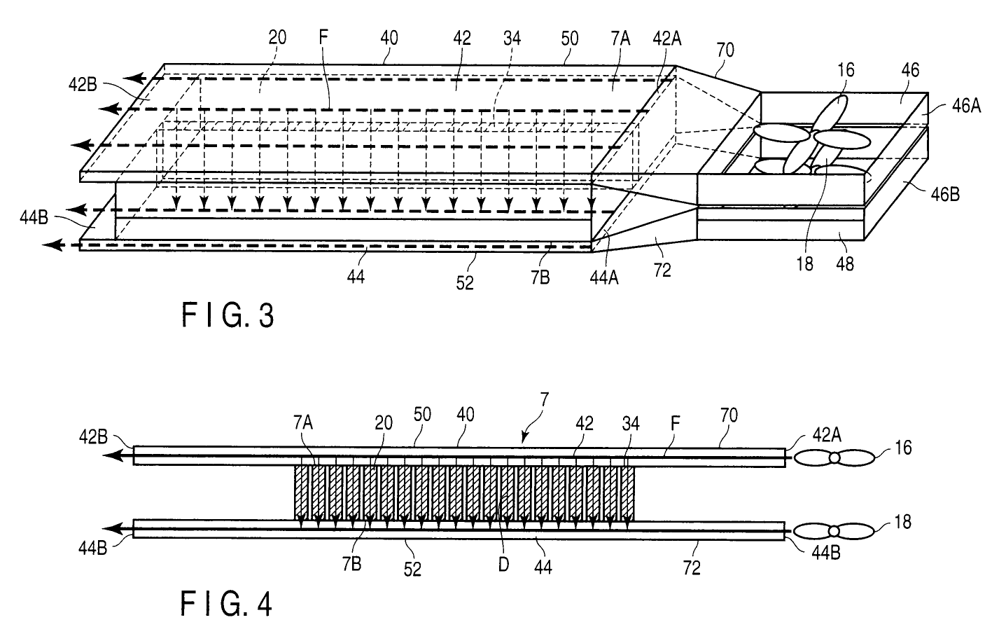

The fuel cell 7 shown in FIG. 2 is contained in a housing 40 as shown in FIG. 3. The housing 40 is provided with an upper duct 50 for defining an upper flow path 42 for passing a cooling airflow (cooling wind) from the first fan 16 on the top surface 7A of the fuel cell 7, and a lower duct 52 for defining a lower flow path 44 for passing a cooling airflow (cooling wind) from the second fan 18 on the under surface 7B of the fuel cell 7. The upper duct 50 and the lower duct 52 respectively have inflow ports 42A, 44A, and outflow ports 42B, 44B for the passing cooling airflows. The first and second fans 16, 18 are each contained in housings 46, 48 each having independent inlet ports 46A, 48A, and the housings 46, 48 are connected to the inflow ports 42A, 44A, respectively by means of upper and lower coupling ducts 70, 72, respectively.

In the fuel cell 7 having the structure described above, when the first and second fans 16, 18 are rotated, cooling air is introduced from the inlet ports 46A, 48A. These airflows are made to flow into the upper flow path 42 and the lower flow path 44 in the upper duct 50, and the lower duct 52 through the coupling ducts 70, 72, are directed to the outflow ports 42B, 44B as indicated by arrows F in FIGS. 3 and 4, and are then made to flow out from the outflow ports 42B, 44B. Accordingly, heat generated from the fuel cell by the reaction is transmitted to the airflows flowing through the upper flow path 42 and the lower flow path 44, and is discharged to the outside. In accordance with the rotational speeds of the first and second fans 16, 18, the flow speeds of the airflows flowing through the upper flow path 42 and the lower flow path 44 change, and a change is caused between the airflows flowing through the upper flow path 42 and the lower flow path 44 in the flow speed. In accordance with the difference in speed, for example, when the flow speed of the first airflow flowing through the upper flow path 42 is larger than the flow speed of the second airflow flowing through the lower flow path 44, a difference in atmospheric pressure is caused between the upper flow path 42 and the lower flow path 44, an air current is made to flow from an opening of the flow path 34 of the airflow of the top surface 7A of the fuel cell 7 into the flow path 34 as indicated by an arrow D, air is positively supplied into the flow path 34, and the reaction in the fuel cell 7 is promoted. Further, the air current made to flow into the flow path 34 is made to flow into the lower flow path 44, and is exhausted from the outflow port 44B together with the airflow flowing through the lower flow path 44. Moisture produced on the cathode side of the fuel cell 7 is exhausted together with the air flowing through the flow path 34, and the carbon dioxide gas produced on the anode side of the fuel cell 7 is exhausted from the output port through flow paths in the anode-side plate 32.

Here, the airflows from the first and second fans 16, 18 cool the fuel cell 7, and also serve as a supply source of oxygen to be consumed in the fuel cell 7. When the amount of heat generated in the fuel cell 7 is large, or sufficient cooling is required, the rotational speeds of the first and second fans 16, 18 are increased. When the heat generation amount of the fuel cell is small, or strong cooling is not required, the rotational speeds of both the fans are reduced. Further, when oxygen is sufficiently supplied to promote the electrochemical reaction in the fuel cell, a difference is given between the rotational speeds of both the fans 16, 18, so that a large difference in atmospheric pressure is given between the upper flow path 42 and the lower flow path 44, and a sufficient amount of air is supplied into the flow path 34. When the supply of oxygen is restrained to suppress the electrochemical reaction in the fuel cell, the difference between the rotational speeds of the first and second fans 16, 18 is reduced, so that the difference in atmospheric pressure between the upper flow path 42 and the lower flow path 44 is reduced, and the amount of air supplied into the flow path 34 is reduced.

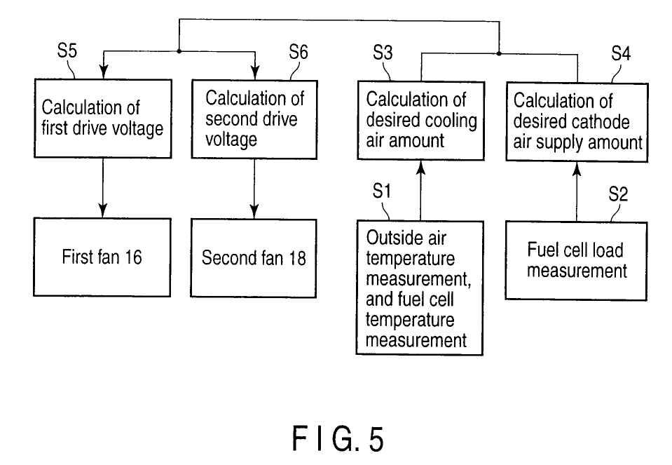

Next, the control operation of the fuel cell system 100 will be described below on the basis of FIG. 5.

In the fuel cell system 100 shown in FIG. 1, the outside air temperature is measured in the control unit by a sensor signal from the outside air temperature sensor 8 prior to the start of generation of electricity as shown in step S1. Further, the control unit 10 is instructed on the set power (target power) by an external input device, and the value of the set power is stored in an internal memory (not shown). After that, a load is set in the load circuit 15, and generation of electricity of the fuel cell 7 is started. Concomitant with the start of generation of electricity, supply of the generated power to the load circuit 15 is started, the temperature of the fuel cell 7 is increased, and the first and second fans 16, 18 are driven to be rotated at an initial rotational speed. When the generated power is settled, a measurement signal from the temperature sensor 6 is supplied to the control unit 10 as shown in step S1, the generated power is measured, a power measurement signal is supplied to the control unit 10, and is compared with the set power (target power) as shown in step S2. In the control unit 10, cooling air amount data (look-up table) stored in the database 12 as the outside air temperature, and the fuel cell temperature is consulted. Further, as shown in step S3, an amount of cooling air corresponding to the set power, to be supplied to each of the upper flow path 42 and the lower flow path 44 based on the outside air temperature and the fuel cell temperature is calculated by the processing unit 14 from the cooling air amount data. Further, cathode air supply amount data (look-up table) also stored in the database 12 as the power measurement signal is consulted, and a cathode air supply amount corresponding to the set power is calculated by the processing unit 14 on the basis of the power measurement signal as shown in step S4. Accordingly, an amount of cooling air to be supplied to each of the upper flow path 42 and the lower flow path 44 is calculated by the processing unit 14 on the basis of the outside air temperature and the fuel cell temperature as shown in step S3.

The control unit 10 obtains the rotational speeds of the first and second fans 16, 18 from the calculated amount of cooling air, and the calculated cathode air supply amount, and calculates first and second drive voltages corresponding to the rotational speeds of the first and second fans 16, 18 in steps S5 and S6. The drivers 21, 23 are set at the obtained first and second drive voltages, respectively, and the fans 16, 18 are rotated at the required rotational speeds as shown in steps S7 and S8. Accordingly, the first and second airflows are supplied to the upper flow path 42 and the lower flow path 44 from the first and second fans 16, 18, the fuel cell 7 is cooled, air flows into the flow path 34 in accordance with the difference between the first and second airflows, and oxygen is supplied to the fuel cell 7. As a result of this, a predetermined electrochemical reaction is caused in the fuel cell in a state where the fuel cell is maintained at a predetermined temperature, and predetermined power is generated from the fuel cell.

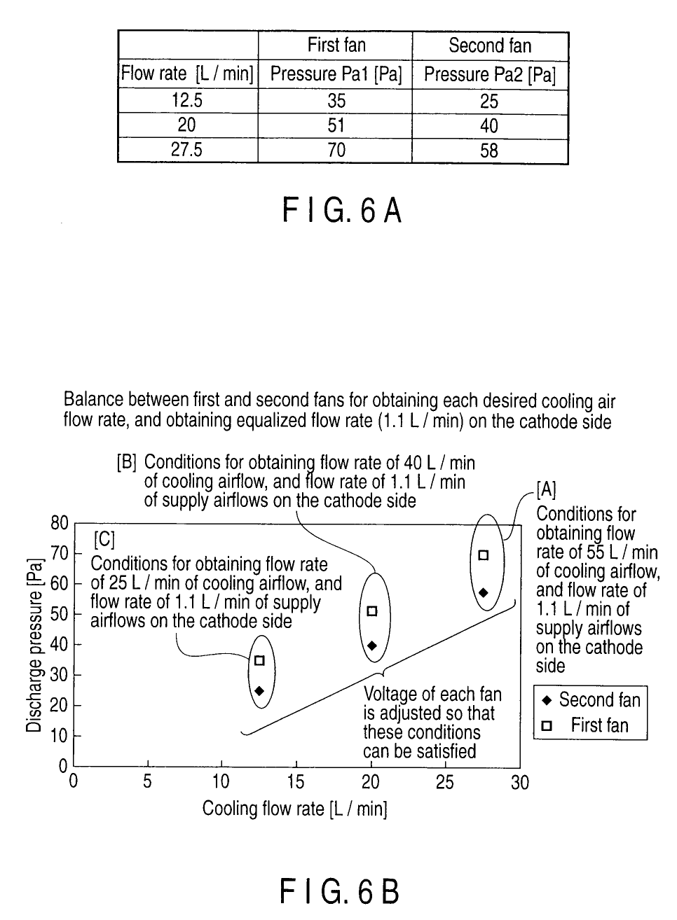

FIG. 6A shows examples of the flow rate [L/min] of the total airflow supplied from the first and second fans 16, 18 shown in FIG. 3, and first and second atmospheric pressures Pa1 [Pa], Pa2 [Pa] applied to the upper duct 50 and the lower duct 52. Air is made to flow into the flow path 34 on the basis of the first and second atmospheric pressures Pa1 [Pa], Pa2 [Pa]. That is, it is shown that the amount of air (supply amount of air) supplied to the cathode side of the fuel cell 7 is adjustable.

FIG. 6B shows examples of the amount of air [L/min] of the total airflow supplied from the first and second fans 16, 18 to cool the fuel cell 7 in the case where the amount of air (supply amount of air) supplied to the cathode side of the fuel cell is set constant, e.g., at a supply amount of air of 1.1 L/min, under the condition that the amount of air of the first fan 16 is set to be greater than the amount of air of the second fan 18. Herein, the amount of air of the total airflow means the sum of the amount of air of the first fan 16 and the second fan 18. In the example [A], the first and second atmospheric pressures (discharge pressure) Pa1 [Pa], Pa2 [Pa] are shown in the case where the amount of air of the total airflow supplied from the first and second fans 16, 18 is 55 L/min. In the example of [B], the first and second atmospheric pressures (discharge pressure) Pa1 [Pa], Pa2 [Pa] are shown in the case where the amount of air of the total airflow supplied from the first and second fans 16, 18 is 40 L/min. In the example of [C], the first and second atmospheric pressures (discharge pressure) Pa1 [Pa], Pa2 [Pa] are shown in the case where the amount of air of the total airflow supplied from the first and second fans 16, 18 is 25 L/min. As is evident from the comparison between the examples [A], [B], and [C], it is possible to vary the total airflow corresponding to the total flow rate of the cooling airflow while the amount of air (supply amount of air) supplied to the cathode side of the fuel cell is maintained constant, i.e., at 1.1 L/min by adjusting the voltages of the fans 16, 18 to adjust the rotational speeds of the fans 16, 18. Accordingly, it is possible to cool the fuel cell in such a manner that the fuel cell is brought into various states, as shown in FIG. 6B.

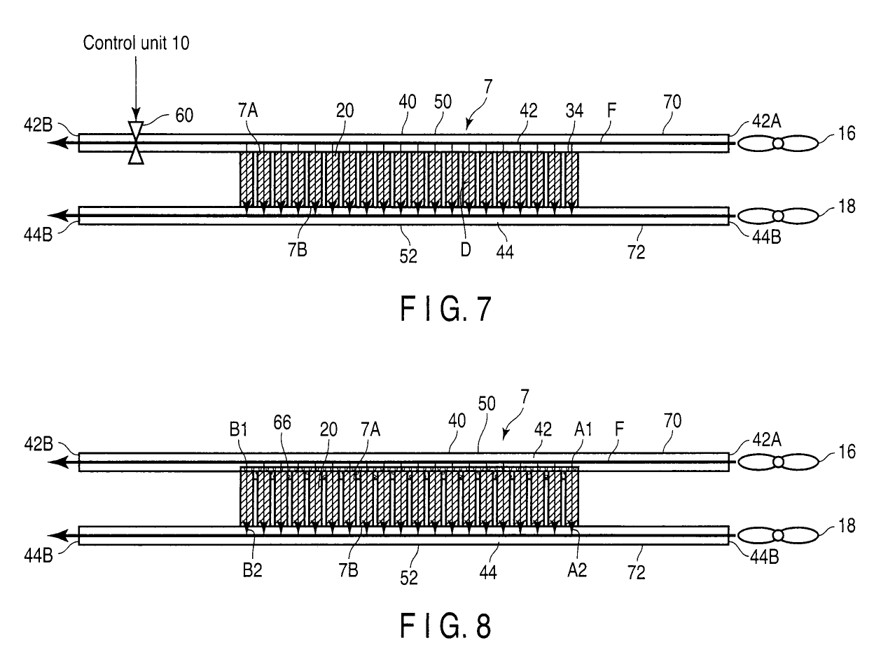

FIGS. 7, 8, and 9 show modified embodiments of the fuel cell 7 shown in FIGS. 3 and 4. In FIGS. 7, 8, and 9, the same parts as those shown in FIGS. 3 and 4 are denoted by the same reference symbols as those shown in FIGS. 3 and 4, and a description of them will be omitted.

In the fuel cell shown in FIG. 7, the upper duct 50 is provided with an adjusting valve 60 for adjusting the internal pressure in the upper duct 50. This pressure adjusting valve 60 can adjust the flow path resistance in the upper duct 50 in accordance with a control signal from the control unit 10. Thus, it is possible to finely adjust the airflow supplied to the inside of the upper duct 50 not only by adjusting the rotational speed of the fan 16, but also by adjusting the flow path resistance in the flow path of the upper duct 50.

Further, in the fuel cell shown in FIG. 7, the supply of air flowing into the flow paths 34 may be adjusted by adjusting the airflow supplied to the inside of the upper duct by means of the pressure adjusting valve 60 while maintaining the rotational speeds of the fans 16, 18 constant. In the fuel cell 7 shown in FIG. 4, when the supply of air made to flow into the cathode side flow path 34 from the upper duct 50 toward the lower duct 52 as indicated by an arrow D is adjusted, the voltage of the first fan 16 is increased, and the voltage of the second fan 18 is decreased. Thus, the first fan 16 is supplied with a current larger than the rated value, and the second fan 18 is supplied with a current smaller than the rated value. Such drive of the fans 16, 18 has a problem that the operation efficiency (air amount/fan power consumption) is not good. Conversely, in the fuel cell shown in FIG. 7, the first and second fans 16, 18 are operated at the rated value at which the efficiency is good, and it becomes possible to increase the internal pressure of the upper flow path 42 by the pressure adjusting valve 60 in a state where the power consumption of the fans 16, 18 is lowered, and operate the fans 16, 18 efficiently.

In the fuel cell shown in FIG. 8, a fluid resistance (resistance part) 66 is provided in the upper flow path 42 in the upper duct 50, and distributed flows made to flow into a plurality of flow paths 34 on the cathode side from the upper duct 50 toward the lower duct 52 are equalized. Here, the fluid resistance 66 may be provided in the lower flow path 44 in the lower duct 52 in place of the upper flow path 42. Alternatively, fluid resistances 66 having different flow path resistances may be provided in the upper flow path 42 and the lower flow path 44. The amount of air of the airflow flowing through each of the upper flow path 42 and the lower flow path 44 for cooling is incomparably larger than the supply amount of air made to flow into the cathode side flow paths. Therefore, the pressure loss from a point A1 to a point B1 (a pressure difference the point A1 and the point B1) in the upper flow path 42 or the pressure loss from a point A2 to a point B2 (a pressure difference the point A2 and the point B2) in the upper flow path 42 is greatly larger than the pressure difference between the point A1 and the point A2 of cathode air supply, or the difference between the point B1 and the point B2. When the amounts of supply of air for cooling in the upper duct 50 and the lower duct 52 are the same flow rate, there is no problem. However, if the amounts of air are different from each other, the amount of cathode air supply largely differs between the flow from the point A1 to the point A2, and the flow from the point B1 to the point B2. Thus, in order to add a pressure difference greater than the pressure loss from the point A1 to the point B1, or that from the point A2 to the point B2 to the air supply toward the cathode side flow paths 34, a fluid resistance is provided, so that the distributed flows made to flow into the cathode side flow paths 34 are equalized.

As the fluid resistance member, for example, a porous member such as a carbon paper or papers, and sintered metal of fine nickel particles can be used.

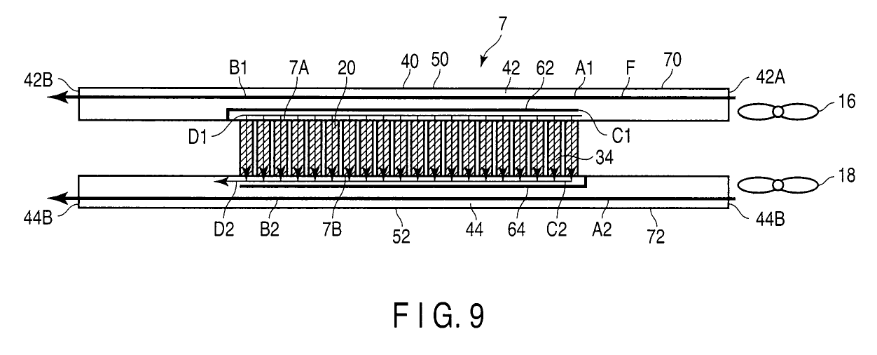

In the fuel cell shown in FIG. 9, shield plates (commutation resistance) 62, 64 are arranged in the upper flow path 42 in the upper duct 50, and in the lower flow path 44 in the lower duct 52, respectively, supply of air for cooling is partly branched by the shield plate 62 into distributaries, and the distributaries are made to flow toward the cathode side flow paths 34. In the distributaries branched by the shield plate, the flow rate is smaller than that of the airflow for cooling shown in FIG. 9, and hence the pressure difference between a point C1 and a point D1, or the pressure loss, i.e., the pressure difference between a point C2 and a point D2 is smaller than the pressure difference between a point A1 and a point B1, or the pressure difference between a point A2 and a point B2, whereby the distributed flows of the cathode side flow paths 34 can be equalized. Here, the shield plate 62 is arranged above the openings of the cathode side flow paths 34, and has a structure in which the plate 62 is opened on the inflow port 42A side, and is closed on the outflow port 42B side, and has a comparatively large flow path resistance. Accordingly, only a part of the cooling air branched by the shield plate 62, and is made to flow into a part above the cathode side flow paths 34 is introduced into the cathode side flow paths 34. Further, the shield plate 64 is also arranged beneath the openings of the cathode side flow paths 34, and has a structure in which the plate 64 is opened on the outflow port 44B side, and is closed on the inflow port 44A side, and has a comparatively large flow path resistance. Accordingly, the supply air made to flow from the cathode side flow paths 34 into the inside of the shield plate 64 is directed from the shield plate 64 to the outflow port 44B to be discharged. The flow of air directed from the shield plate 64 to the outflow port 44B may not join the cooling flow, and may be discharged to the outside as it is.

In the fuel cell system according to the embodiment, it is possible to realize a cathode air supply method utilizing a part of the cooling air which enables reduction in size, low cost, and ease of control.

As has been described above, according to the present invention, there is provided a fuel cell system which is small in size, and is easy to control, and a cooling air supply method thereof.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fuel cell system comprising:
first and second airflow generation parts configured to generate first and second cooling airflows, respectively;
a fuel cell having first and second surfaces faced to each other and including a cathode-side plate having air flow paths, an anode-side plate having fuel flow paths through which fuel flows, and a membrane electrode assembly arranged between the cathode-side and the anode-side plates, and in contact with the air flow paths and the fuel flow paths, wherein the air flow paths has first openings at one ends thereof, which are arranged on the first surface, and the air flow paths has second openings at the other ends thereof, which are arranged in the second surface;
a housing which receive the fuel cell, the housing having inner surfaces defining first and second cooling flow paths between the inner surfaces and the first and second surfaces, respectively, wherein the first and second cooling airflows flows through the first and second cooling flow paths, respectively, and the first cooling flow path is communicated with the second cooling flow path through the air flow paths; and
a control unit configured to control a pressure difference between the first and second cooling airflows in the first and second cooling flow paths, respectively, to control airflows introduced from the first cooling flow path into the air flow paths in accordance with the pressure difference.

2. The system according to claim 1, wherein the housing includes first and second ducts having the inner surfaces and defining the first and second cooling flow paths on the first and second surfaces.

3. The system according to claim 1, wherein the control unit controls a flow rate of each of the first and second cooling airflows generated from the first and second airflow generation parts.

4. The system according to claim 1, wherein the first and second airflow generation parts include first and second fans which generate the first and second cooling airflows, respectively and
the control unit controls the rotations of the first and second fans, respectively.

5. The system according to claim 1, wherein the control unit controls a flow rate of each of the first and second cooling airflows in accordance with a predetermined cooling amount required to cool the fuel cell, and a predetermined supply amount of air to be supplied into the air flow paths.

6. The system according to claim 1, further comprising:
a valve provided in one of the first and second cooling flow paths, wherein the control unit controls the valves to adjust an internal pressure in the one cooling flow path.

7. The system according to claim 1, further comprising:
a resistance part provided in one of the first and second cooling flow paths, which equalizes distributed flows of the supply air flowing from the one cooling flow path into the air flow paths.

8. The system according to claim 1, further comprising:
a flow resistance provided in one of the first and second cooling flow paths, which partly branches the cooling airflow flowing through the one cooling flow path into distributed flow, and adjusts the distributed flow into the air flow path.

9. A method of controlling a cooling airflow for a fuel cell, the fuel cell having first and second surfaces faced to each other, and including a cathode-side plate having air flow paths, an anode-side plate having fuel flow paths through which fuel flows, and a membrane electrode assembly arranged between the cathode-side and the anode-side plates, and in contact with the air flow paths and the fuel flow paths; said method comprising:
supplying first and second cooling airflows into first and second cooling flow paths defined on the first and second surfaces, respectively, wherein the first cooling flow path is communicated with the second cooling flow path through the air flow paths; and
controlling the pressure difference between the first and second cooling airflows in the first and second cooling flow paths, respectively, to control airflows introduced from the first cooling flow path into the air flow paths in accordance with the pressure difference.

10. The method according to claim 9, wherein the controlling includes setting a flow rate of each of the first and second cooling airflows.

11. The method according to claim 9, wherein a flow rate of each of the first and second cooling airflows is controlled in accordance with a predetermined cooling amount required to cool the fuel cell, and a predetermined supply amount of air to be supplied into the air flow paths.

12. The method according to claim 9, wherein the controlling includes restricting an internal pressure in one of the first and second cooling flow paths.

13. The method according to claim 9, wherein the cooling airflow flowing through one of the first and second cooling flow paths is partly branched into distributed flow, and the distributed flow are supplied into the air flow paths.
